(19) United States
(12) Patent Application Publication
(10) Pub. No.: US 2014/0316830 A1
(43) Pub. Date: Oct. 23, 2014

(54) Synchronized Resource Planning

(71) Applicant: CloudLogix, LLC, Denver, CO (US)

(72) Inventors: Robert K. Langhorne, III, Grapevine, TX (US); Robert K. Langhorne, IV, Denver, CO (US)

(21) Appl. No.: 14/254,743

(22) Filed: Apr. 16, 2014

Related U.S. Application Data
(60) Provisional application No. 61/949,902, filed on Mar. 7, 2014.
(60) Provisional application No. 61/812,948, filed on Apr. 17, 2013.

(51) Int. Cl. G06Q 10/06

(52) U.S. Cl. CPC G06Q 10/0631
USPC 705/7.12

(57) ABSTRACT

Various implementations described herein are directed to a non-transitory computer readable medium having stored thereon computer-executable instructions which, when executed by a computer, may cause the computer to receive an inbound message from a resource planning software application that is a member of a set of resource planning software applications. The computer may determine whether the inbound message conflicts with local data used by the set of resource planning software applications. The computer may determine whether the inbound message conflicts with outbound messages that are to be transmitted to at least one resource planning software application in the set of resource planning software applications. The computer may generate an outbound message configured to modify the local data used by the set of resource planning software applications in response to the data contained within the inbound message.

### CROSS-REFERENCE TO RELATED APPLICATIONS

This application claims the benefit of U.S. Provisional Patent Application Ser. No. 61/812,948, filed Apr. 17, 2013 and titled SUPPLY CHAIN SOFTWARE, and U.S. Provisional Patent Application Ser. No. 61/949,902, filed Mar. 7, 2014 and titled SYNCHRONIZED RESOURCE PLANNING, the disclosures of which are incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Resource planning is a core activity and problem set that is performed by all organizations. Because of organic growth, changing market demands, or mergers and acquisitions, the resource planning model is often performed by different applications, not all of which are compatible or capable of sharing data. Companies often install monolithic applications from a single provider to solve this problem.

### SUMMARY

Described herein are implementations of various technologies for a method for receiving inbound messages and generating outbound messages. In one implementation, a non-transitory computer-readable medium having stored thereon computer-executable instructions which, when executed by a computer, cause the computer to perform various actions. The actions may include receiving an inbound message from a resource planning software application that is a member of a set of resource planning software applications. The actions may include determining whether the inbound message conflicts with local data used by the set of resource planning software applications. The actions may also include determining whether the inbound message conflicts with outbound messages that are to be transmitted to at least one resource planning software application in the set of resource planning software applications. An outbound message that is configured to modify the local data used by the set of resource planning software applications in response to the data contained within the inbound message may be generated.

Described herein are also implementations of various technologies for a computer system for receiving inbound messages and generating outbound messages. The computer system includes a processor and memory. The memory has a plurality of executable instructions. In one implementation, when the executable instructions are executed by the processor, the processor may receive an inbound message from a resource planning software application that is a member of a set of resource planning software applications. The processor may determine whether the inbound message conflicts with local data used by the set of resource planning software applications. The processor may determine whether the inbound message conflicts with outbound messages that are to be transmitted to at least one resource planning software application in the set of resource planning software applications. The processor may generate an outbound message that is configured to modify the local data used by the set of resource planning software applications in response to the data contained within the inbound message.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a diagram of a Synchronized Resource Planner in accordance with implementations of various techniques described herein.

FIG. 2 illustrates various processes or threads that are part of a Synchronized Resource Planner in accordance with implementations of various techniques described herein.

FIG. 3 illustrates a flow diagram of a method for an incoming data adapter in accordance with implementations of various techniques described herein.

FIG. 4 illustrates a flow diagram of a method for adapter adjudication in accordance with various implementations described herein.

FIG. 5 illustrates a flow diagram of a method for message synchronization and processing in accordance with various implementations described herein.

FIG. 6 illustrates a flow diagram of a method for message distribution in accordance with various implementations described herein.

FIG. 7 illustrates a flow diagram of a method for outgoing data adapters in accordance with various implementations described herein.

FIG. 8 illustrates a diagram of messages transmitted during synchronized resource planning in accordance with implementations of various techniques described herein.

FIG. 9 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

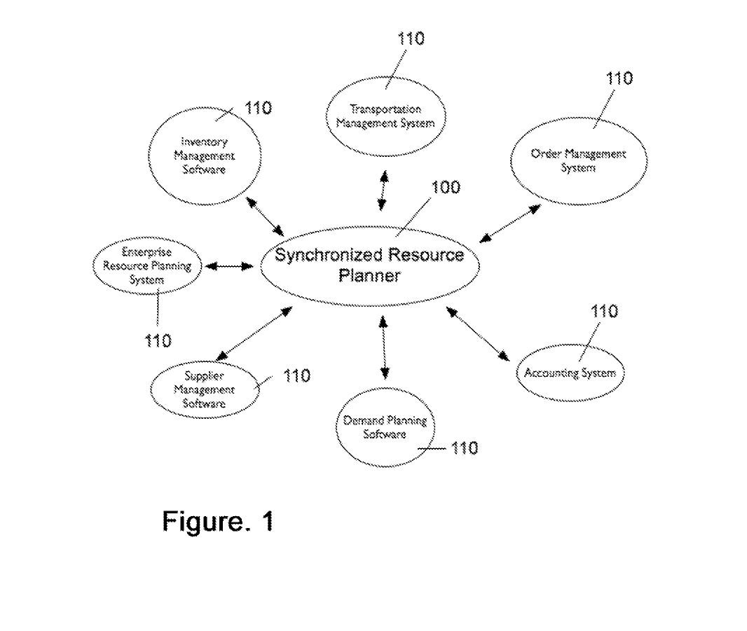

Various implementations for synchronizing resource planning software applications will now be described in more detail with reference to FIGS. 1-9.

The following paragraphs provide a brief overview of various implementations described herein, which are directed to synchronization of supply chain data that includes a fast and intelligent transfer of data between a set of disparate resource planning software applications to ensure that each resource planning software application has a complete view of data. Synchronization may be performed by a computer software application that may be referred to herein as a Synchronized Resource Planner. The Synchronized Resource Planner correlates, retrieves, and synchronizes relevant transaction information from multiple data sources and uses a business rules engine to ensure data quality and integrity on each transaction. The engine can reject a single transaction or an entire set of transactions based on a set of rules. The Synchronized Resource Planner may execute any number of notification steps to correct error or suspect data. Once data is corrected, the Synchronized Resource Planner may learn from the correction and future occurrences of similar errors may be corrected. The Synchronized Resource Planner may then send validated data to one or more systems, using distribution rules, in a safe store-and-forward mechanism with retry attempts and error correction.

In one implementation, the Synchronized Resource Planner may be used to replace or augment an enterprise resource planning system, which is a software system used to manage business processes. The Synchronized Resource Planner may bring the set of data (for example, a local database) employed in any participating resource planning software application to an equivalent state with all other participating resource planning software applications.

FIG. 1 illustrates a diagram of the Synchronized Resource Planner 100 in accordance with implementations of various techniques described herein.

The Synchronized Resource Planner 100 may receive or retrieve inbound messages from synchronization nodes 110. The Synchronized Resource Planner 100 may transmit outbound messages to synchronization nodes 110, or queue outbound messages for retrieval by a synchronization node 110. The Synchronized Resource Planner 100 may be implemented as a cloud software service, i.e., portions of the software may be executed on any number of local or remote computer systems 900 which may be located in one location, such as one datacenter, or in more than one location. The computer systems 900 may be connected using a public or private network, such as the Internet.

A synchronization node 110 may be any resource planning software application, including inventory management software (IMS), a transportation management system (TMS), an order management system (OMS), an accounting system, demand planning software, supplier management software, an enterprise resource planning system (ERP), or any other supply chain system, business process system, resource planning system, or business application. A synchronization node 110 may be a piece of software running on a computer or server. In one implementation, a Synchronized Resource Planner 100 may be used to synchronize the local data used by a set of resource planning software applications. For example, a Synchronized Resource Planner 100 may be used to synchronize the local data used by every resource planning software application used by a business. In another example, a Synchronized Resource Planner 100 may be used to synchronize the resource planning software applications used by a business with the resource planning software applications used by the business's suppliers or customers.

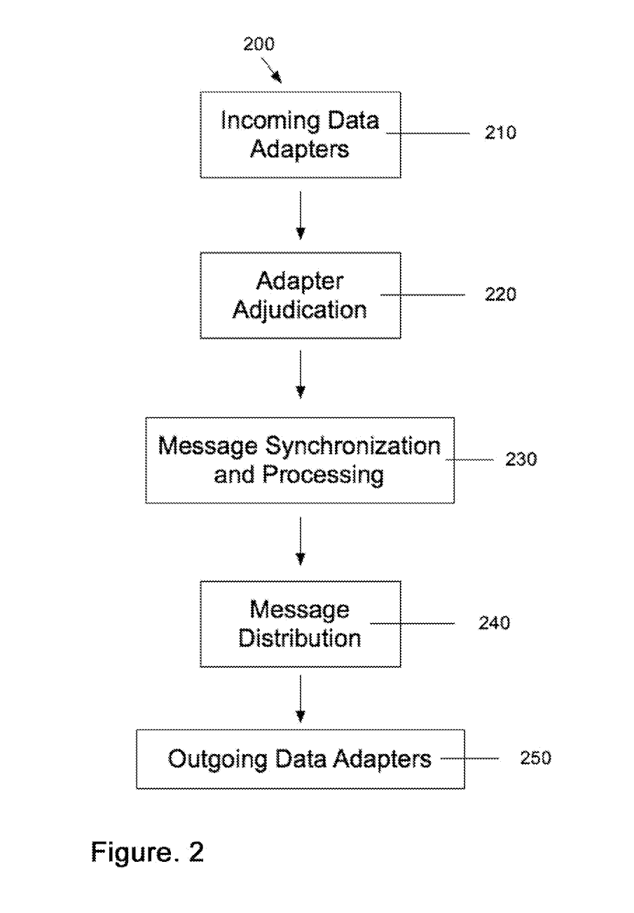

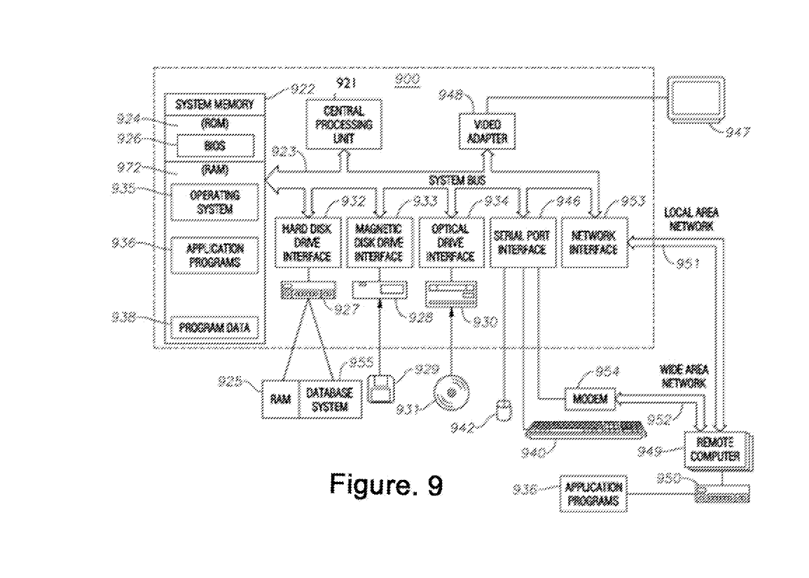

FIG. 2 illustrates various processes or threads that are part of the Synchronized Resource Planner 200 described herein. In one implementation, these processes may be performed by any computing device, such as computer system 900, described in FIG. 9. It should be understood that while the flow diagram 200 indicates a particular order of execution of operations, in some implementations, certain portions of the operations may be executed in a different order. Certain portions of the operations may be executed simultaneously. Further, in some implementations, additional operations or steps may be added to the flow diagram 200. Likewise, some operations or steps may be omitted. Additionally, the operations may be executed on more than one computerized device, and the computerized devices may be in more than one location. For example, portions of the Synchronized Resource Planner 200 may be executed on the systems of a synchronization node 110, and other portions may be executed as part of a cloud service.

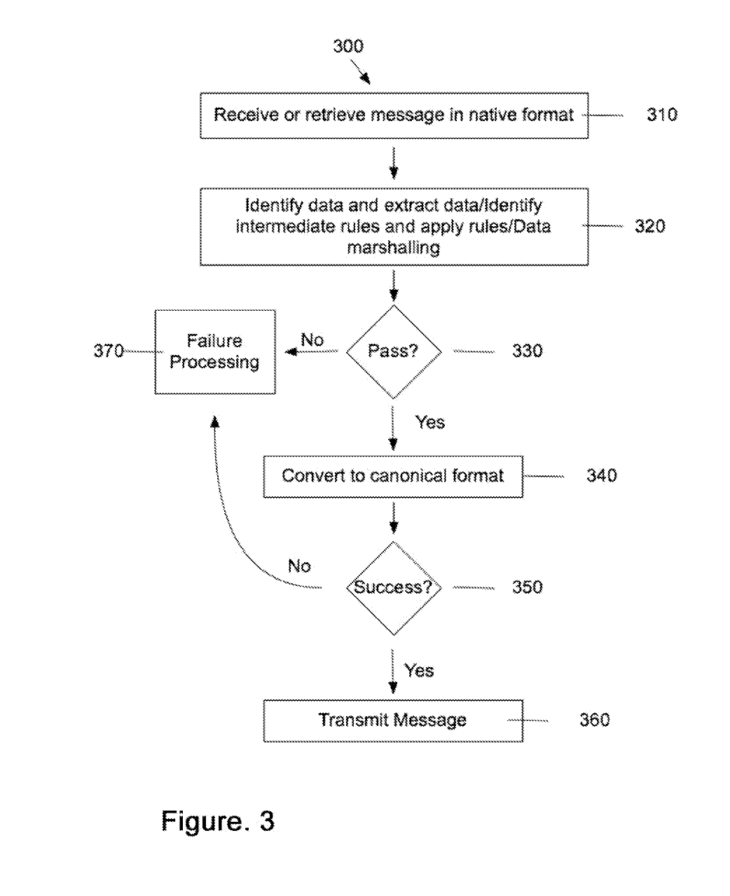

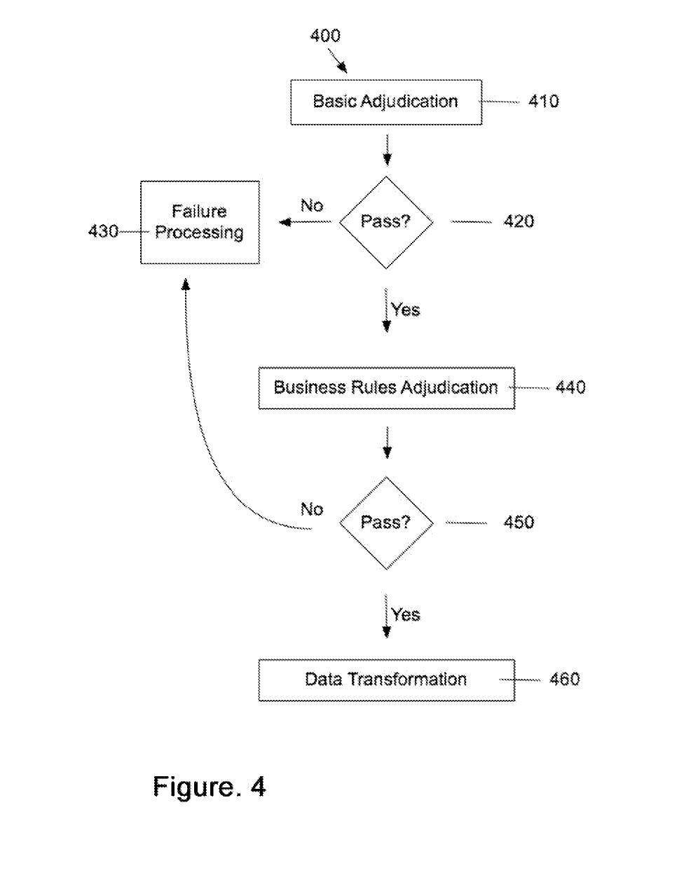

As mentioned above, the computer system 900 may be loaded with a set of instructions (software) to run the Synchronized Resource Planner 200. The Synchronized Resource Planner 200 may synchronize the data of a set of resource planning software applications (i.e., synchronization nodes 110). At block 210, incoming data adapters may receive or retrieve an inbound message from a synchronization node 110. The incoming data adapters may convert the inbound message from a format native to the synchronization node 110 to an internal canonical format. This process is described in further detail in FIG. 3 and accompanying text. At block 220, adapter adjudication may occur to ensure that the inbound message passes one or more sets of rules. Adapter adjudication 220 may determine whether the inbound message is valid. Adapter adjudication 220 may determine whether the inbound message conflicts with local data used by a synchronization node 110 that is a member of the set of resource planning software applications. This process is described in further detail in FIG. 4 and accompanying text.

At block 230, message synchronization and processing may occur. During message synchronization and processing, multiple messages may be synchronized, conflicts between the inbound message and other messages may be detected and managed, and other processing may occur. Message synchronization at block 230 may determine whether the inbound message conflicts with outbound messages being held in a queue prior to transmission.

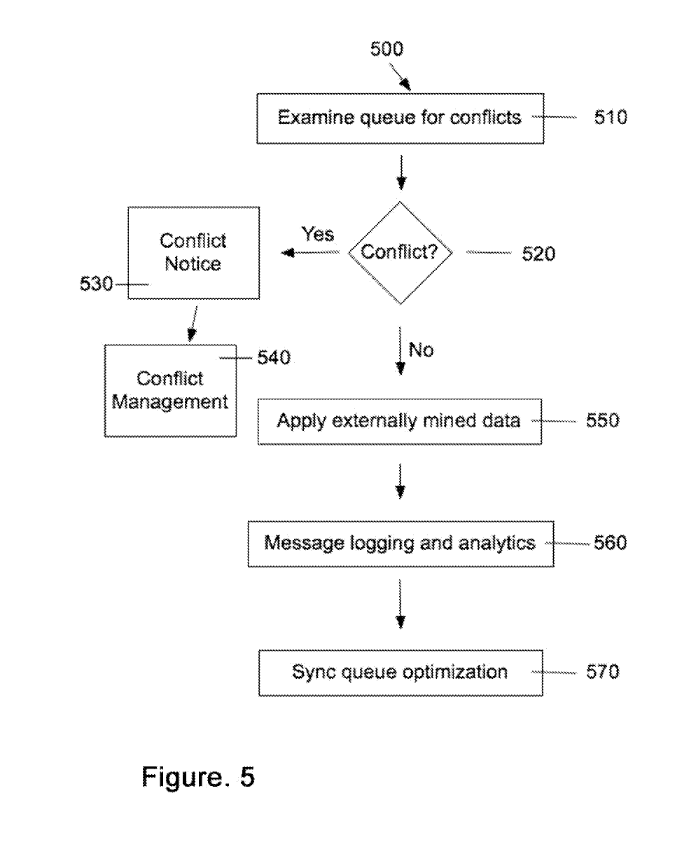

Additionally, at block 230, the relevancy of mined data to the inbound message may be determined, and messages may be flagged or altered using the mined data. This process is described in further detail in FIG. 5 and accompanying text.

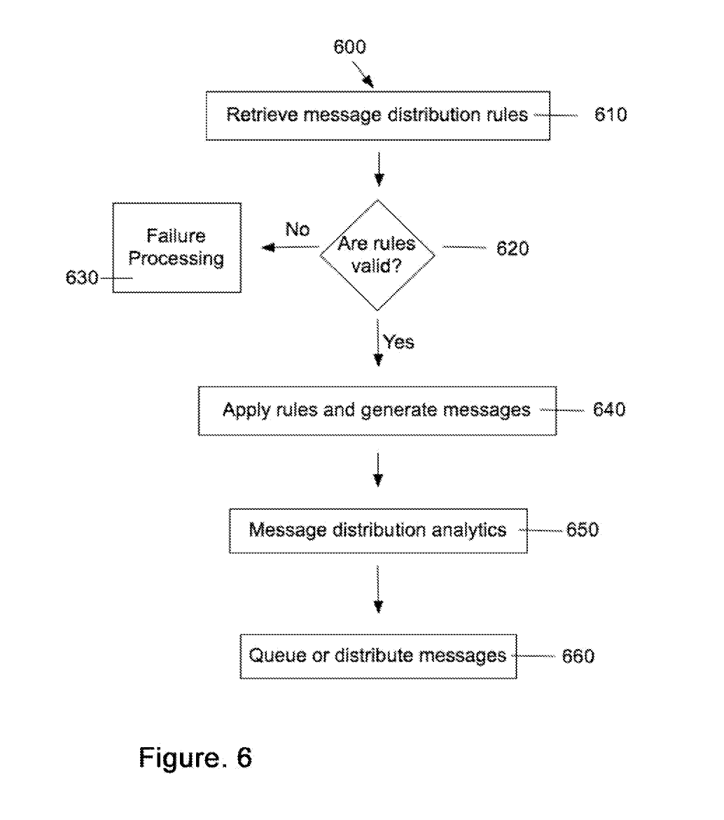

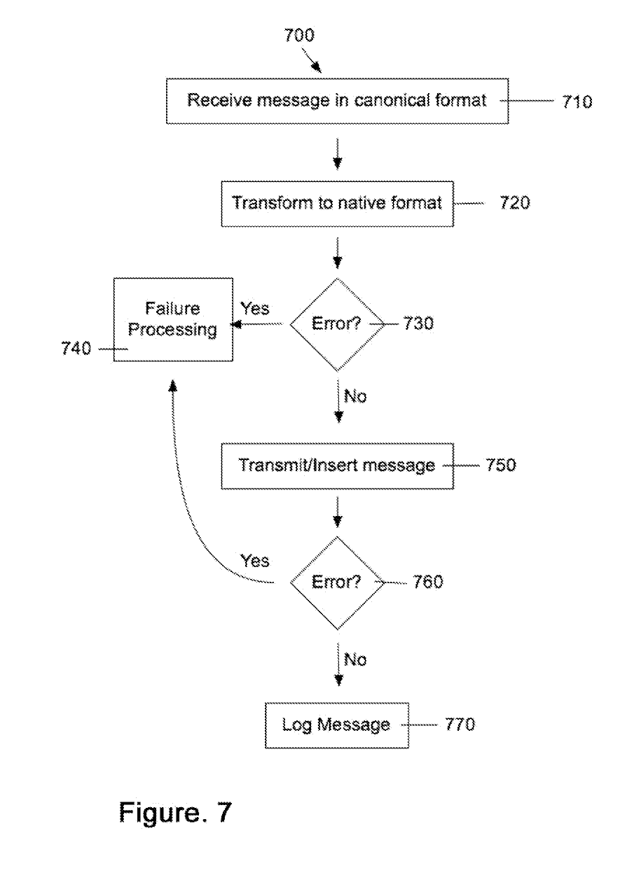

At block 240, message distribution may occur. During message distribution, outbound messages in canonical format may be generated for distribution, in response to the inbound message. A set of rules may be applied to the inbound message to generate the outbound messages. The outbound messages may be generated to place synchronization nodes 110 in an equivalent state. Placing synchronization nodes 110 in an equivalent state may reduce or eliminate conflicting information within a system of synchronization nodes 110. Placing synchronization nodes 110 in an equivalent state may include propagating a change made to the local data of one synchronization node 110 throughout a system of synchronization nodes 110. For example, if the price of a product is lowered in the database of one synchronization node 110, the system may be placed in an equivalent state by lowering the price of the product in the databases of all other synchronization nodes 110 in the system. This process is described in further detail in FIG. 6 and accompanying text. At block 250, outgoing data adapters may transmit outbound messages to synchronization nodes 110. The outgoing data adapters may convert the canonical format outbound messages to native format outbound messages. This process is described in further detail in FIG. 7 and accompanying text.

FIG. 3 illustrates a flow diagram of a method 300 for an incoming data adapter in accordance with implementations of various techniques described herein. In one implementation, method 300 may be performed by any computing device, such as computer system 900, described in FIG. 9. It should be understood that while method 300 indicates a particular order of execution of operations, in some implementations, certain portions of the operations may be executed in a different order. Certain portions of the operations may be executed simultaneously. Further, in some implementations, additional operations or steps may be added to method 300. Likewise, some operations or steps may be omitted. Additionally, the operations may be executed on more than one computerized device, and the computerized devices may be in more than one location. For example, method 300 may be executed on the systems of a synchronization node 110, on a cloud service of the Synchronized Resource Planner 100, or portions of method 300 may be executed on both.

As mentioned above, the computer system 900 may be loaded with a set of instructions (software) to perform method 300. At block 310, the incoming data adapter may receive or retrieve inbound messages from a synchronization node 110. The inbound messages may be in a format native to the synchronization node 110. The data adapter may be either an active or on-demand adapter. An active adapter may retrieve messages at block 310, whereas an on-demand adapter may receive messages at block 310. The type of adapter used may be selected based on the interfaces available at the synchronization node 110.

Active adapters may be used to retrieve, or pull, data from synchronization nodes 110 that do not send, or push, data. Active adapters may retrieve information from a data storage model. For example, active adapters may be used to retrieve data from a database, a file system, a legacy application, or a file transfer mechanism, such as File Transfer Protocol (FTP).

On-demand adapters may be used to receive data from synchronization nodes 110 that can send, or push, data directly to the adapter. These synchronization nodes 110 may have mechanisms for sending data to an on-demand adapter based on an independent event that occurs in the synchronization node 110. For example, messages may be received from synchronization nodes 110 through electronic data interchange (EDI), legacy integration software, or custom interfaces.

At block 320, the inbound message may be identified, extracted, and marshaled. A data identification process may be used to determine if there is data to synchronize. If data to synchronize is identified, an extraction process may be used to extract data from the inbound message. The identification and extraction processes may be specific to an individual synchronization node 110 or type of synchronization node 110.

After extraction, the software may determine whether there is sufficient data available for message synchronization. For example, the software may compare the extracted data to a threshold of minimum changes that must be accumulated before the synchronization node 110 will participate in a synchronization operation. Also, an intermediate rules identification process may be used to determine if there are rules to be applied to the inbound message. The intermediate rules may be specific to a synchronization node 110 or to an individual data adapter. The rules may then be applied to the inbound message.

At block 330, a check may be performed to determine whether the rules identification process at block 320 succeeded. The check may also determine if the rules at block 320 were applied successfully to the message. The check at 330 may also determine whether there is sufficient data available for message synchronization. If the check does not pass, failure processing may occur at block 370. For example, if the extracted data does not meet the minimum threshold of changes, the process may not continue until additional inbound messages are received or retrieved. In another example, if application of the intermediate rules is not successful or results in an error, failure processing 370 may occur. Failures may be processed at block 370 by notifying a user or synchronization node 110 of the failure.

Otherwise, if the check at block 330 does pass, the extracted data may be converted to a new message in canonical format at block 340. This new message in canonical format may be referred to herein as a synchronization message. The canonical format may be an internal format used for storing business process data. The canonical format may store data and instructions in an Extensible Markup Language (XML) format. Examples of data and instructions that may be stored in a synchronization message in canonical format include address, batch line, containers, contract, customer, goods in, goods out, invoice, location, milestone, mission, product, route, shipment handling unit, service level agreement, suppliers, and waypoint. Although the canonical format is described as an XML based format, the canonical format may be any data type capable of storing business process data.

At block 340, a check may be performed to determine whether conversion to canonical format was successful. If not, failure processing 370 may occur.

If the conversion is successful, the synchronization message in canonical format may be transmitted at block 360 to an adapter adjudication process, described below with reference to FIG. 4. Alternately, the synchronization message may be saved for future processing or transmitted to a cloud service. For example, if method 300 is implemented in software as a function, after execution of the function is complete, the function may return the synchronization message, or a reference to the synchronization message.

FIG. 4 illustrates a flow diagram of a method 400 for adapter adjudication in accordance with various implementations described herein. In one implementation, method 400 may be performed by any computing device, such as computer system 900, described in FIG. 9. It should be understood that while method 400 indicates a particular order of execution of operations, in some implementations, certain portions of the operations may be executed in a different order. Certain portions of the operations may be executed simultaneously. Further, in some implementations, additional operations or steps may be added to method 400. Likewise, some operations or steps may be omitted. Additionally, the operations may be executed on more than one computerized device, and the computerized devices may be in more than one location. For example, method 400 may be executed as part of a cloud service.

As mentioned above, the computer system 900 may be loaded with a set of instructions (software) to perform method 400. At block 410, basic adjudication may occur. Basic adjudication 410 may determine whether the inbound synchronization message complies with a set of rules. The rules may be system wide rules pertaining to a set of resource planning software applications. For example, the rules may be system wide rules used by the resource planning software applications of one business. Basic adjudication 410 may determine if the synchronization message has all mandatory data elements that must be present for synchronization. The mandatory data elements may be specific to a type of synchronization message, a user or a system. For example, in a system in which the local rules at a synchronization node 110 do not require a telephone number, but the system does require telephone numbers, basic adjudication may determine if the synchronization message includes a telephone number, and alert the synchronization node 110 if a telephone number is missing. In another example, the number of mandatory elements may be greater for an “add” message than for an “update” message. At block 420, failure processing 430 occurs if the adjudication fails, otherwise business rules adjudication 440 occurs.

Failure processing 430 may display a dialog box asking a user to manage the error, for example by correcting an inbound message corresponding to the synchronization message, or the synchronization message. Failure processing 430 may also send an email or another type of message to a user describing the failure. The failure may be a soft failure, in which the message may be corrected and processing may continue at block 440. Alternately, the failure may be a hard failure, in which the message does not continue. If the failure is a hard failure, the inbound message corresponding to the synchronization message may be sent back to the user or synchronization node 110.

At block 440, business rules adjudication may occur. At business rules adjudication 440, a set of business rules may be applied to the synchronization message. The business rules may be specific to a user or system. The business rules may be learned or adjusted using analytics. For example, the business rules may be automatically adjusted based on prior failure processing. The business rules may include multi-element rules or data threshold rules. Applying the business rules at block 440 may include transmitting data to and receiving data from a synchronization node 110. The business rules may ensure that data in the synchronization message is consistent with data throughout a system composed of multiple synchronization nodes 110. The business rules may determine whether the inbound message conflicts with the local data used by a synchronization node 110. The local data used by a synchronization node may be stored in a database, or any other data storage model. For example, if the synchronization message indicates that an order for an item has been placed at an OMS, at block 440 the business rules may determine, by querying an IMS, whether a sufficient quantity of the item is available in inventory to fulfill the order.

At block 450, a check may occur to determine whether the application of business rules to the synchronization message was successful. If not, failure processing 430 may occur. For example, if the synchronization message is not consistent with information stored at one of the synchronization nodes 110 in the system, failure processing 430 may occur. If the application is successful, then data transformation may occur at block 460. Data transformation 460 may determine whether data transformation rules apply to the synchronization message, and may apply those rules. The data transformation rules may adjudicate and convert data from an old data format to a new data format. For example, if a synchronization message includes data (e.g., the price of a product) in one currency, data transformation 460 may convert the data to a different currency.

FIG. 5 illustrates a flow diagram of a method 500 for message synchronization and processing in accordance with various implementations described herein. In one implementation, method 500 may be performed by any computing device, such as computer system 900, described in FIG. 9. It should be understood that while method 500 indicates a particular order of execution of operations, in some implementations, certain portions of the operations may be executed in a different order. Certain portions of the operations may be executed simultaneously. Further, in some implementations, additional operations or steps may be added to method 500. Likewise, some operations or steps may be omitted. Additionally, the operations may be executed on more than one computerized device, and the computerized devices may be in more than one location. For example, method 500 may be executed as part of a cloud service.

As mentioned above, the computer system 900 may be loaded with a set of instructions (software) to perform method 500. At block 510, the software may examine synchronization messages for conflicts. The messages to be examined may be received by the method 500. For example, method 500 may be implemented as a function and the messages may be received as a parameter when the function is called. The messages to be examined may also be in a queue for distribution to a synchronization node 110. For example, the method 500 may receive a message as a parameter and determine if any conflicts exist between the received message and a queue of outbound messages. If there is only one message to examine, the process may proceed directly to block 550, without examining for conflicts.

In one implementation, the software may examine the inbound message and all outbound messages that have not yet been transmitted to synchronization nodes 110 to determine whether any conflicts exist. The software may also examine other inbound messages that have not yet been synchronized to determine whether any conflicts exist. For example, if the software is implemented as a cloud service, the software may determine whether a conflict exists between the inbound message and all other synchronization messages within the cloud service.

Conflicting messages may be messages that would lead to inconsistencies within a system. For example, one “add product” message may describe a new product and include the weight of the product as 10.0 pounds, while a second “add product” message describes the same product, but states that the weight of the product is 10.2 pounds. These messages would be conflicting.

At block 520, the software may determine whether a conflict was detected at block 510. If a conflict exists, the conflicting messages may be removed from the queue. The conflicting messages may be placed in a temporary queue while the conflict is resolved. A conflict notice may be transmitted to a user or system at block 530. For example, a conflict notice may be sent to one or more data adapters, which may notify a user and allow the user to resolve the conflict by modifying one or more synchronization messages. At block 540, the conflict is managed. The conflict may be resolved at block 540 by a user or system correcting one or more messages. The conflict may be resolved automatically using rules. For example, if a message is received from an ERP adding a new item with a stated price, and a message is received from a TMS adding the same item but with a different price, the rules may dictate that the ERP price is always correct, and the messages may be modified accordingly without any user intervention.

If no conflicts exist at block 520, or if a conflict has been resolved, externally mined data may be applied at block 550. Externally mined data may be mined using a web crawling engine, a semantic analysis engine, a fuzzy logic decision support module, a cluster analysis module, or combinations thereof. The externally mined data may be mined from external sources, such as Rich Site Summary (RSS, also commonly referred to as Really Simple Syndication) feeds, web sites, or any other digital data source. Applying externally mined data at block 550 may compare mined data to a synchronization message to determine relevance. In one example, if it is determined that the mined data is relevant to the synchronization message, a notification may be transmitted to the synchronization node 110. In a second example, the message may be altered, or flagged, to notify a user or system of the relevant mined data. In a third example, a new message may be created, and the new message may describe the mined data, and may also describe the relevancy of the mined data to the synchronization message.

The synchronization message may also be altered automatically in response to the mined data. For example, if a shipment is traveling through a port in New York City, and mined data determines that there is a workers' strike at that port, a notification may be sent to the synchronization node 110 that entered the shipment. In another example, the route may be automatically modified to avoid the port with striking workers in New York City.

At block 560, message logging and analytics may occur. Synchronization messages may be stored in a log. Additionally, data regarding any conflicts may be logged. For example, the existence of a conflict may be logged, and the process used to resolve the conflict may be logged. The software may then perform analytics on the logged messages and other logged data, and the resulting data may be stored for further analytics or modeling. For example, clustering techniques may be used to group similar conflicts, and this information may be used to identify and correct the source of reoccurring conflicts.

At block 570, a queue of synchronization messages may be optimized to improve efficiency. Synchronization messages may be grouped or sorted by type. For example, the messages may be grouped by the type of request. Synchronization messages may be ordered for efficient insertion in a synchronization node 110 database or data source. The synchronization messages may be optimized. For example, the messages may be examined to determine whether any messages can be merged, while still including all necessary data. In another example, a message may be merged or deleted if it is superseded by rules. If only one message exists in the synchronization queue, the optimization process may simply return the message without performing optimization.

FIG. 6 illustrates a flow diagram of a method 600 for message distribution in accordance with various implementations described herein. In one implementation, method 600 may be performed by any computing device, such as computer system 900, described in FIG. 9. It should be understood that while method 600 indicates a particular order of execution of operations, in some implementations, certain portions of the operations may be executed in a different order. Certain portions of the operations may be executed simultaneously. Further, in some implementations, additional operations or steps may be added to method 600. Likewise, some operations or steps may be omitted. Additionally, the operations may be executed on more than one computerized device, and the computerized devices may be in more than one location. For example, method 600 may be executed as part of a cloud service.

As mentioned above, the computer system 900 may be loaded with a set of instructions (software) to perform method 600. At block 610, message distribution rules may be retrieved by the message distribution method 600. For example, message distribution method 600 may be implemented in software, and the software may retrieve the message distribution rules from a database. The message distribution rules may be specific to a user, system, or type of message. The message distribution rules may be applied to a synchronization message to determine the immediacy of distribution. The message distribution rules may be applied to a synchronization message to determine the adapters to include in the distribution. The message distribution rules may determine the data to include in each generated messages. The message distribution rules may determine which synchronization nodes 110 will receive messages. For example, the rules for a “new supplier data” message may be different than the rules for an “order data” message. In another example, the rules may be different for a message originating from a TMS than the rules for a message originating from an ERP. The message distribution rules may be adjusted using information determined during message distribution analytics 650.

At block 620, the software may determine if the message distribution rules are valid for the message type, the specific message, or both. If the message distribution rules are not valid, failure processing may occur at block 630. The failure processes may be specific to the type of error and to the user or system. For example, failure processing at block 630 may include displaying an error notification, or sending an e-mail message.

If the rules are determined to be valid at block 620, then the software may apply the message distribution rules to generate outbound messages at block 640. The generated outbound messages may be generated in canonical format. These messages may be generated to place all synchronization nodes 110 in a system in an equivalent state. The generated messages may be configured to modify the local data used by a synchronization node 110. In one example, a new product is added in a synchronization node 110, which generates an inbound “add product” message that is transmitted to a Synchronized Resource Planner 100. Applying message distribution rules to the “add product” synchronization message may then generate outbound messages, in response to the inbound message, for each synchronization node 110. The outbound messages may add the new product information to each nodes' local data.

At block 650 message distribution analytics may occur. Message distribution analytics may examine the outbound messages to find patterns or trends. These patterns or trends may then be used to adjust the message distribution rules. For example, message distribution may perform cluster analysis on the outbound messages to find patterns. Message distribution analytics 650 may also suggest changes that should be made to message distribution rules or to any other rules. For example, if a pattern is found at block 650 using cluster analysis, a suggestion for changing message distribution rules in response to the pattern may be displayed to a user.

At block 660, generated outbound synchronization messages may be queued or distributed. The generated synchronization message may be placed in a deferred queue to be held prior to transmission to a synchronization node 110. Synchronization of a deferred queue may occur at a predetermined time or interval, when another process or synchronization node 110 makes a request to synchronize, or when the queue reaches a threshold volume. For example, a synchronization node 110 may request to synchronize messages, and all messages from the deferred queue may then be transmitted to the synchronization node 110, using a data adapter. Alternately, at block 660, the generated synchronization message may be placed in an outbound queue for immediate distribution. After being placed in either a deferred queue or outbound queue in block 660, a synchronization message may then be transmitted to an outgoing data adapter.

FIG. 7 illustrates a flow diagram of a method 700 for outgoing data adapters in accordance with implementations of various techniques described herein. In one implementation, method 700 may be performed by any computing device, such as computer system 900, described in FIG. 9. It should be understood that while method 700 indicates a particular order of execution of operations, in some implementations, certain portions of the operations may be executed in a different order. Certain portions of the operations may be executed simultaneously. Further, in some implementations, additional operations or steps may be added to method 700. Likewise, some operations or steps may be omitted. Additionally, the operations may be executed on more than one computerized device, and the computerized devices may be in more than one location. For example, method 700 may be executed on the systems of a synchronization node 110, on a cloud service, or portions of method 700 may be executed on both.

As mentioned above, the computer system 900 may be loaded with a set of instructions (software) to perform method 700. At block 710, the software may receive an outbound message in canonical format. For example, the message may be received by retrieving a message from a queue of messages. In another example, the message may be passed to method 700 as a parameter.

At block 720, the outbound message may be transformed from canonical format to a native format. The native format may be a format compatible with the destination synchronization node 110. For example, the native format may be a message to transmit to the destination synchronization node 110. In another example, the native format may be a database query to execute on the destination synchronization node 110. The outbound message in native format may be configured to modify the local data used by the destination synchronization node 110.

At block 730, the software may determine if the message transformation that occurred at block 720 was successful. If not, failure processing may occur at 740. A failure may be handled at block 740 by notifying a user or synchronization node 110 of the error. The failure processes used at block 740 may be specific to a synchronization node 110, user, or system.

At block 750 the data adapter may transmit the message to a synchronization node 110, or insert the message into the database or other data storage mechanism of a synchronization node 110.

In an active adapter, the adapter may use functionality that is native to the synchronization node 110 to apply the synchronization message to the data. For example, the adapter may use Data Manipulation Language (DML) statements to insert the message into a database, or apply the message to a database. In another example, the adapter may use an import format native to a synchronization node 110.

In an on-demand adapter, the adapter may transmit the message at block 750 by calling functionality native to a synchronization node 110 in order to apply the synchronization message. For example, a message may be transmitted using EDI, legacy integration software, or custom interfaces.

At block 760, the software may determine whether an error occurred while transmitting or inserting the synchronization message at block 750. If an error occurred, failure processing 740 may be used to manage the error. If no error occurred at block 750, then the transmission of the message may be logged at block 770 for analysis.

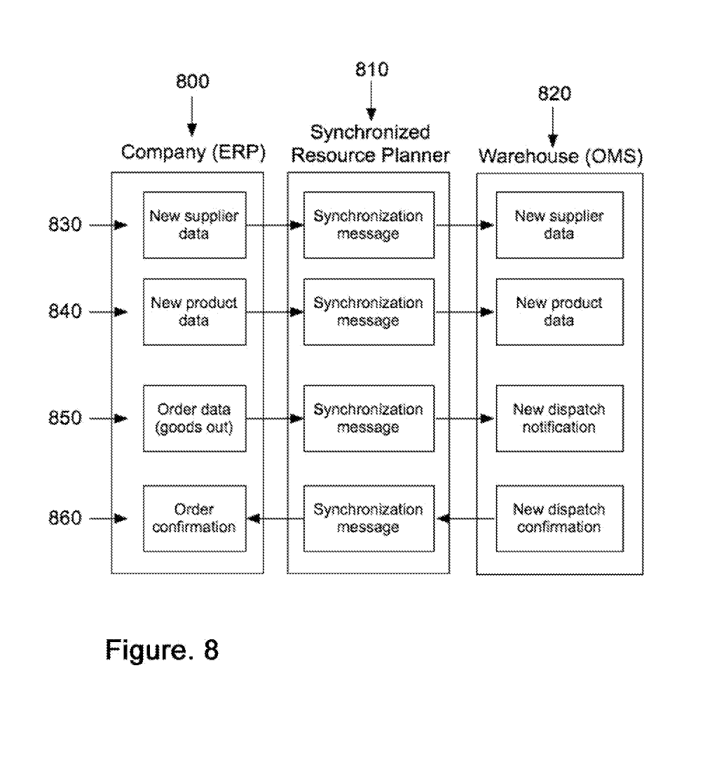

FIG. 8 illustrates a diagram of messages transmitted during synchronized resource planning in accordance with implementations of various techniques described herein. Enterprise resource planning system (“ERP”) 800 and order management system (“OMS”) 820, which are synchronization nodes 110, transmit messages to a Synchronized Resource Planner 810, and receive messages from the Synchronized Resource Planner 810. The ERP 800 and OMS 820 are members of a set of resource planning software applications. Messages in FIG. 8 are shown as being generated at either the ERP 800 or the OMS 820, and then synchronized using the Synchronized Resource Planner 810. Although this figure displays a Synchronized Resource Planner 810 receiving or retrieving a single message and transmitting a single corresponding message to one synchronization node 110, the Synchronized Resource Planner 810 may retrieve multiple messages, and may transmit multiple messages to multiple synchronization nodes 110.

At 830, new supplier information is entered into the ERP 800. An inbound message, in a format native to the ERP, may be either transmitted by the ERP 800 or retrieved by the Synchronized Resource Planner 810. The inbound message may contain data describing the new supplier. The Synchronized Resource Planner 810 may then extract the data from the native format inbound message and create a canonical format synchronization message with the extracted information. The canonical format synchronization message in 830 contains information regarding the new supplier. Then, message distribution rules may be applied to the synchronization message to determine which synchronization nodes 110 require outbound messages and what data those outbound messages should include. The message distribution rules then dictate that an outbound “new supplier data” message should be transmitted to the OMS 820 in a format native to the OMS 820.

At 840, new product data is entered into the ERP 800, and a “new product data” inbound message is generated. The Synchronization Resource Planner 810 is then shown as translating this inbound “new product data” message to a canonical format synchronization message containing data regarding the new product. Message distribution rules may be applied to the synchronization message, resulting in an outbound “new product data” message being transmitted to the OMS 820.

At row 850, the ERP 800 transmits an inbound message to the Synchronized Resource Planner 810 to notify the organization that an order for goods has occurred. The incoming data adapter 300 may extract data from the native format inbound “order data” message to create a canonical format synchronization message containing data regarding the order for goods. During adapter adjudication 400, if business rules dictate, the Synchronized Resource Planner 810 may determine if there is sufficient inventory of the ordered item at a distribution center. If there is not sufficient inventory or if a failure occurs, the Synchronized Resource Planner 810 may notify a user with a notification window, send an e-mail, or send an SMS notification. Otherwise, the Synchronized Resource Planner 810 may save information regarding the message and perform supply chain tracking and analysis using the contents of the message. Then, during message distribution 600, the Synchronization Resource Planner 810 may apply message distribution rules to the synchronization message, which may result in a canonical format “save order” outbound message being transmitted to an outgoing data adapter 700 for the OMS 820. The outgoing data adapter 700 may then translate the canonical format “save order” message to a native format “new dispatch notification” outbound message.

At row 860, a “new dispatch confirmation” message is transmitted from the OMS 820 to the Synchronized Resource Planner 810. The Synchronized Resource Planner 810 then extracts the data from the native “new dispatch confirmation” message and creates a synchronization message in canonical format. After applying the message distribution rules to the canonical message, the Synchronized Resource Planner 810 generates a “get outbound goods order” message in canonical format to be distributed to the outgoing data adapter 700 for the OMS 820, and a “save order” message in canonical format to be distributed to the outgoing data adapter 700 for the ERP 800. An “order confirmation” message is then transmitted to the ERP in native format using the outgoing data adapter 700.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments, including a cloud computing environment, where tasks are performed by remote processing devices that are linked through a communications network, e.g., by hardwired links, wireless links, or combinations thereof. In a distributed computing environment, program modules may be located in both local and remote computer storage media including memory storage devices.

FIG. 9 illustrates a computer system 900 into which implementations of various technologies and techniques described herein may be implemented. Computing system 900 may be a conventional desktop, a handheld device, a wearable electronic device, a controller, a personal digital assistant, a server computer, an electronic device/instrument, a laptop, a tablet, or part of a cloud computing system. It should be noted, however, that other computer system configurations may be used.

The computing system 900 may include a central processing unit (CPU) 921, a system memory 922 and a system bus 923 that couples various system components including the system memory 922 to the CPU 921. Although only one CPU is illustrated in FIG. 9, it should be understood that in some implementations the computing system 900 may include more than one CPU. The system bus 923 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 922 may include a read only memory (ROM) 924 and a random access memory (RAM) 925. A basic input/output system (BIOS) 926, containing the basic routines that help transfer information between elements within the computing system 900, such as during start-up, may be stored in the ROM 924. The computing system may be implemented using a printed circuit board containing various components including processing units, data storage memory, and connectors.

The computing system 900 may further include a hard disk drive 927 for reading from and writing to a hard disk, a magnetic disk drive 928 for reading from and writing to a removable magnetic disk 929, and an optical disk drive 930 for reading from and writing to a removable optical disk 931, such as a CD ROM or other optical media. The hard disk drive 927, the magnetic disk drive 928, and the optical disk drive 930 may be connected to the system bus 923 by a hard disk drive interface 932, a magnetic disk drive interface 933, and an optical drive interface 934, respectively. The drives and their associated computer-readable media may provide nonvolatile storage of computer-readable instructions, data structures, program modules and other data for the computing system 900.

Although the computing system 900 is described herein as having a hard disk, a removable magnetic disk 929 and a removable optical disk 931, it should be appreciated by those skilled in the art that the computing system 900 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 900. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 927, magnetic disk 929, optical disk 931, ROM 924 or RAM 925, including an operating system 935, one or more application programs 936, program data 938, and a database system 955. The one or more application programs 936 may contain program instructions configured to perform methods 200, 300, 400, 500, 600, and 700 according to various implementations described herein. The operating system 935 may be any suitable operating system that may control the operation of a networked personal or server computer, such as Windows® XP, Mac OS® X, Unix-variants (e.g., Linux® and BSD®), and the like.

A user may enter commands and information into the computing system 900 through input devices such as a keyboard 940 and pointing device 942. Other input devices may include a microphone, joystick, game pad, satellite dish, scanner, user input button, or the like. These and other input devices may be connected to the CPU 921 through a serial port interface 946 coupled to system bus 923, but may be connected by other interfaces, such as a parallel port, game port or a universal serial bus (USB). A monitor 947 or other type of display device may also be connected to system bus 923 via an interface, such as a video adapter 948. In addition to the monitor 947, the computing system 900 may further include other peripheral output devices such as speakers and printers.

Further, the computing system 900 may operate in a networked environment using logical connections to one or more remote computers 949. The logical connections may be any connection that is commonplace in offices, enterprise-wide computer networks, intranets, and the Internet, such as local area network (LAN) 951 and a wide area network (WAN) 952. The remote computers 949 may each include application programs 936 similar to that as described above.

When using a LAN networking environment, the computing system 900 may be connected to the local network 951 through a network interface or adapter 953. When used in a WAN networking environment, the computing system 900 may include a modem 954, wireless router or other means for establishing communication over a wide area network 952, such as the Internet. The modem 954, which may be internal or external, may be connected to the system bus 923 via the serial port interface 946. In a networked environment, program modules depicted relative to the computing system 900, or portions thereof, may be stored in a remote memory storage device 950. It will be appreciated that the network connections shown are exemplary and other means of establishing a communications link between the computers may be used.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon computer-executable instructions which, when executed by a computer, cause the computer to:
receive an inbound message from a resource planning software application that is a member of a set of resource planning software applications;
determine whether the inbound message conflicts with local data used by the set of resource planning software applications;
determine whether the inbound message conflicts with outbound messages that are to be transmitted to at least one resource planning software application in the set of resource planning software applications; and
generate an outbound message configured to modify the local data used by the set of resource planning software applications in response to the data contained within the inbound message.

2. The non-transitory computer-readable medium of claim 1, wherein the instructions that cause the computer to determine whether the inbound message conflicts with the local data comprises instructions that cause the computer to check whether the inbound message is consistent with the local data.

3. The non-transitory computer-readable medium of claim 1, wherein the instructions that cause the computer to determine whether the inbound message conflicts with the local data comprises instructions that cause the computer to determine whether there is sufficient inventory to process the inbound message.

4. The non-transitory computer-readable medium of claim 1, wherein the outbound messages that are to be transmitted are contained in a queue.

5. The non-transitory computer-readable medium of claim 1, wherein the outbound message configured to modify the local data is a database query.

6. The non-transitory computer-readable medium of claim 1, further comprising instructions that cause the computer to provide notification of any failures that occur when the outbound message configured to modify the local data is generated.

7. The non-transitory computer-readable medium of claim 1, further comprising instructions that cause the computer to provide notification of any failures that occur when determining whether the inbound message conflicts with local data.

8. The non-transitory computer-readable medium of claim 1, further comprising instructions that cause the computer to provide notification of any failures that occur when determining whether the inbound message conflicts with the outbound messages.

9. The non-transitory computer-readable medium of claim 1, further comprising instructions that cause the computer to automatically correct any conflicts between the inbound message and the outbound message that are to be transmitted.

10. The non-transitory computer-readable medium of claim 1, further comprising instructions that cause the computer to automatically correct any conflicts between the inbound message and the local data used by the set of resource planning software applications.

11. The non-transitory computer-readable medium of claim 1, further comprising instructions that cause the computer to compare externally mined data to the inbound message and determine whether the externally mined data is relevant to the inbound message.

12. The non-transitory computer-readable medium of claim 11, further comprising instructions that cause the computer to automatically modify the inbound message in response to the externally mined data.

13. The non-transitory computer-readable medium of claim 11, further comprising instructions that cause the computer to provide notification regarding the externally mined data.

14. The non-transitory computer-readable medium of claim 11, wherein the externally mined data comprise data mined using semantic analysis, fuzzy logic mining, cluster analysis, or combinations thereof.

15. The non-transitory computer-readable medium of claim 1, further comprising instructions that cause the computer to determine whether the inbound message complies with system wide rules pertaining to the set of resource planning software applications.

16. The non-transitory computer-readable medium of claim 1, further comprising instructions that cause the computer to determine whether the inbound message conflicts with other inbound messages that have not yet been synchronized.

17. The non-transitory computer-readable medium of claim 1, further comprising instructions that cause the computer to optimize the inbound message with the outbound messages by determining whether the inbound message and the outbound messages can be merged or organized more efficiently.

18. The non-transitory computer-readable medium of claim 1, further comprising instructions that cause the computer to hold the inbound message and a conflicting outbound message until the inbound message or the conflicting outbound message is modified.

19. A computer system, comprising:
a processor; and
a memory having program instructions that cause the processor to:
receive an inbound message from a resource planning software application that is a member of a set of resource planning software applications;
determine whether the inbound message conflicts with local data used by the set of resource planning software applications;
determine whether the inbound message conflicts with outbound messages that are to be transmitted to at least one resource planning software application in the set of resource planning software applications; and
generate an outbound message configured to modify the local data used by the set of resource planning software applications in response to the data contained within the inbound message.

20. The computer system of claim 19, wherein the memory further comprises instructions that cause the processor to provide notification of any failures that occur when determining whether the inbound message conflicts with the outbound messages.
